(19) United States
(12) Patent Application Publication
(10) Pub. No.: US 2026/0001446 A1
(43) Pub. Date: Jan. 1, 2026

(54) BATTERY CONTROL SYSTEM AND BATTERY CONTROL METHOD

(71) Applicant: HONDA MOTOR CO., LTD., Tokyo (JP)

(72) Inventors: Fuminori Fujino, Tokyo (JP); Takeshi Itagaki, Tokyo (JP)

(21) Appl. No.: 19/214,341

(22) Filed: May 21, 2025

(30) Foreign Application Priority Data
Jun. 27, 2024 (JP) 2024-104321
Mar. 31, 2025 (JP) 2025-058304

(51) Int. Cl. B60L 58/20; B60L 58/15; H02J 7/00

(52) U.S. Cl. CPC B60L 58/20; B60L 58/15; H02J 7/00302; H02J 7/0048; H02J 7/00712; H02J 7/007194; H02J 2310/48

(57) ABSTRACT

A battery control system includes an upper-level control unit and a lower-level control unit. The upper-level control unit includes a battery information acquisition unit, a vehicle information acquisition unit, a threshold value setting unit that sets a threshold value defining a charge amount of a second battery based on battery information, and a chargeability determination unit that determines whether the second battery can be charged based on vehicle information and transfers a determination result and the threshold value to the lower-level control unit. The lower-level control unit includes a charge amount monitoring unit that monitors the charge amount of the second battery, and a charging necessity determination unit that transfers a charge request for the second battery to the upper-level control unit when the determination result indicates that the second battery can be charged and the charge amount is equal to or lower than the threshold value.

### INCORPORATION BY REFERENCE

The present application claims priority under 35 U.S.C. § 119 to Japanese Patent Application No. 2024-104321 filed on Jun. 27, 2024, and Japanese Patent Application No. 2025-058304 filed on Mar. 31, 2025. The content of the application is incorporated herein by reference in its entirety.

### BACKGROUND OF THE INVENTION

### Field of the Invention

The present invention relates to a battery control system and a battery control method.

### Description of the Related Art

In recent years, research and development relating to battery charging, which contributes to energy efficiency, is being carried out in order to secure access to sustainable and advanced energy that is affordable and reliable to more people. U.S. Unexamined Patent Application Publication No. 2023/0144284 discloses an auxiliary charging system for charging a low-voltage battery with the electric power of a high-voltage battery by using a DC-to-DC converter, when the remaining capacity of the low-voltage battery is less than a threshold value. It is disclosed that, in this system, deterioration of the low-voltage battery is prevented by not fully charging the battery during auxiliary charging; and an integrated central control unit (ICU) transfers information relating to a vehicle to an integrated charging control unit (ICCU), and the ICCU transmits an auxiliary charge request based on the information relating to the vehicle.

Here, the present technique relating to battery charging has the task of shortening the duration and lowering the power consumption of control related to the charging and ensuring appropriate battery charge amounts for a second battery being a low-voltage battery or the like that is charged with electric power from a first battery being a high-voltage battery or the like.

For example, in a conventional configuration, monitoring of the charge amount (for example, state of charge (SoC)) of the second battery is carried out by a control unit at an upper-level side, but monitoring accuracy decreases due to time lag until battery information from a control unit at a terminal side is transferred and the like. This results in an increase in communication traffic, which is disadvantageous for lowering power consumption.

Hypothetically, when the battery is replaced with a battery having a different performance, a situation may occur in which the charge amount of the battery is insufficient if monitoring accuracy is low.

In order to solve the above-described problems, the present application has an object to accelerate and lower power consumption of control related to battery charging and ensure an appropriate charge amount of a battery, by using a configuration in which a plurality of control units operate in cooperation with one another. Furthermore, the present application contributes to energy efficiency.

### SUMMARY OF THE INVENTION

An aspect according to the present disclosure is a battery control system installed in a mobile body, the battery control system including: an upper-level control unit that controls charging of a first battery storing electric power for driving a power unit and a second battery charged with electric power of the first battery; and a lower-level control unit that monitors the second battery. The upper-level control unit includes: a battery information acquisition unit that acquires battery information relating to the first battery and the second battery; a mobile body information acquisition unit that acquires mobile body information relating to the mobile body; a threshold value setting unit that sets a threshold value defining a charge amount of the second battery, based on the battery information; and a chargeability determination unit that determines whether the second battery can be charged based on the mobile body information, and transfers a determination result and the threshold value to the lower-level control unit. The lower-level control unit includes: a charge amount monitoring unit that monitors the charge amount of the second battery; and a charging necessity determination unit that transfers a charge request for the second battery to the upper-level control unit, when the determination result indicates that the second battery can be charged and the charge amount is equal to or lower than the threshold value.

Another aspect according to the present disclosure is a battery control method executed by a mobile body, the mobile body including: an upper-level control unit that controls charging of a first battery storing electric power for driving a power unit and a second battery charged with electric power of the first battery; and a lower-level control unit that monitors the second battery. The upper-level control unit executes: a battery information acquisition step of acquiring battery information relating to the first battery and the second battery; a mobile body information acquisition step of acquiring mobile body information relating to the mobile body; a threshold value setting step of setting a threshold value defining a charge amount of the second battery, based on the battery information; and a chargeability determination step of determining whether the second battery can be charged based on the mobile body information, and transferring a determination result and the threshold value to the lower-level control unit. The lower-level control unit executes: a charge amount monitoring step of monitoring the charge amount of the second battery; and a charging necessity determination step of transferring a charge request for the second battery to the upper-level control unit, when the determination result indicates that the second battery can be charged and the charge amount is equal to or lower than the threshold value.

According to the aspects of the present invention, it is possible to accelerate and lower power consumption of control related to battery charging and ensure an appropriate charge amount of the battery, by using a configuration in which a plurality of control units operate in cooperation with one another.

### BRIEF DESCRIPTION OF THE DRAWINGS

FIG. 1 is a diagram showing a battery control system according to a first embodiment;

FIG. 2 is a flowchart showing a battery control method;

FIG. 3 is a diagram showing an example of a temporal change in a charge amount of a second battery;

FIG. 4 is a diagram showing an example of determination processing in step S3;

FIG. 5 is a diagram showing another example of a temporal change in the charge amount of the second battery;

FIG. 6 is a diagram for describing emergency auxiliary charging;

FIG. 7 is a diagram showing the second battery and a second lower-level control unit according to a second embodiment;

FIG. 8 is a flowchart showing control processing of a relay;

FIG. 9 is a diagram for describing a first modified example; and

FIG. 10 is a diagram for describing a second modified example and a third modified example.

### DETAILED DESCRIPTION OF THE INVENTION

Hereinafter, embodiments according to the present invention will be described with reference to the drawings.

### First Embodiment

### 1. Configuration of Battery Control System 1

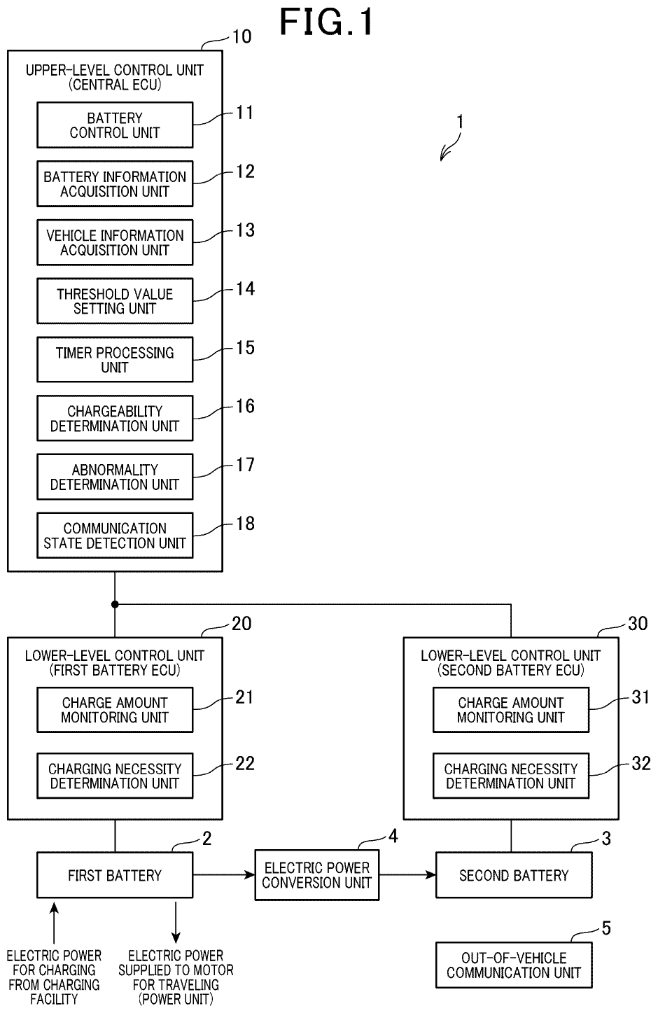

FIG. 1 is a diagram showing a battery control system 1 according to a first embodiment.

The battery control system 1 includes an upper-level control unit 10 consisting of a central ECU that performs overall control and information processing of a mobile body. The upper-level control unit 10 is connected to a plurality of ECUs for controlling an operation of the mobile body via a communication line, and implements a gateway function of managing transmission and reception of communication data.

FIG. 1 shows, among the plurality of ECUs communicably connected to the upper-level control unit 10, a lower-level control unit 20 consisting of a first battery ECU that monitors a first battery 2 of the mobile body and a lower-level control unit 30 consisting of a second battery ECU that monitors a second battery 3 of the mobile body. The upper-level control unit 10 and the lower-level control units 20 and 30 operate in cooperation with one another to charge the first battery 2 and the second battery 3.

The mobile body in which the battery control system 1 is installed is a vehicle classified as an Electric Vehicle (EV). The mobile body includes a motor for traveling that functions as a power unit, the first battery 2 being a high-voltage battery with a relatively large capacity storing electric power for driving the motor for traveling, and the second battery 3 being a low-voltage battery with a relatively small capacity storing electric power for driving auxiliary equipment of the vehicle. The vehicle may be a hybrid-type electric vehicle (for example, an HEV). The mobile body according to the present disclosure is not limited to a vehicle and may also be an aircraft or a ship.

The first battery 2 and the second battery 3 are secondary batteries, and are lithium-ion batteries in the present embodiment. The first battery 2 is charged with electric power from a charging facility. The motor for traveling also functions as a regenerative brake and electric power generated thereby is collected into the first battery 2. Electric power stored in the first battery 2 is converted to electric power for motor driving, and is supplied to the motor for traveling as well as being used for charging the second battery 3. Note that the first battery 2 can be referred to as a main battery or a battery for traveling. The second battery 3 can be referred to as a sub-battery or a battery for auxiliary equipment.

The vehicle includes an electric power conversion unit 4 that converts electric power stored in the first battery 2 and an out-of-vehicle communication unit 5 that communicates with an external server. The electric power conversion unit 4 includes a DC-to-DC converter that converts electric power stored in the first battery 2 to electric power for charging the second battery 3. The out-of-vehicle communication unit 5 comprises a transmitter and a receiver and is used for telematics, software updates, and the like.

The upper-level control unit 10 has a microcomputer configuration and includes a processor, a memory, and the like. The upper-level control unit 10 functions as a battery control unit 11, a battery information acquisition unit 12, a vehicle information acquisition unit 13, a threshold value setting unit 14, a timer processing unit 15, a chargeability determination unit 16, an abnormality determination unit 17, and a communication state detection unit 18, through the processor loading and executing a program stored in the memory.

The battery control unit 11 performs processing of controlling the charging of the first battery 2 and the second battery 3 by using a monitoring result of the lower-level control units 20 and 30. Note that the battery control unit 11 may directly control the charging of the first battery 2 and the second battery 3, or may control the charging of the first battery 2 and the second battery 3 via another ECU such as a lower-level control unit.

The battery information acquisition unit 12 performs processing of acquiring battery information relating to the first battery 2 and the second battery 3. The battery information includes the monitoring result (including charge amounts) of the first battery 2 and the second battery 3 by the lower-level control units 20 and 30, and information (voltage, current, temperature, and the like) detected by a battery management unit (hereinafter referred to as BMU) provided in the batteries 2 and 3.

In the present embodiment, as information indicating the charge amounts of the batteries 2 and 3, state of charge (SoC) is used that is estimated from voltages of the batteries 2 and 3 or calculated by integrating currents of the batteries 2 and 3. By using SoC, it is possible to accurately identify the charge amounts of the batteries 2 and 3. However, the information indicating the charge amounts is not limited to SoC.

Note that the battery information acquisition unit 12 can also be a battery voltage acquisition unit, a battery current acquisition unit, a battery temperature acquisition unit, or a battery charge amount acquisition unit.

The vehicle information acquisition unit 13 performs processing of acquiring vehicle information being information relating to the vehicle. The vehicle information is information detected by a sensor or the like provided in the vehicle. The vehicle information includes information indicating an operation state of the vehicle, information indicating an open/closed state of an opening/closing member included in the vehicle, and information (outside air temperature and the like) related to battery charging.

The information indicating the operation state of the vehicle is information for identifying that the vehicle is traveling, the vehicle is stopped (parked), the first battery 2 is being charged, the second battery 3 is being charged, the electric power conversion unit 4 is operating while the vehicle is parked, and the like. The information includes, for example, information such as the vehicle being powered on (for example, ignition being turned on), the vehicle being powered off (for example, ignition being turned off), and a speed of the vehicle.

The opening/closing member included in the vehicle includes a hood (also referred to as bonnet), doors, and a trunk of the vehicle. The open/closed states of these opening/closing members are detected by a sensor provided in the vehicle and transferred to the vehicle information acquisition unit 13. Note that the vehicle information is an example of mobile body information.

The threshold value setting unit 14 performs processing of setting threshold values related to the charging of the second battery 3 based on the temperature of the second battery 3. For example, the threshold value setting unit 14 can set each threshold value based on table data indicating correspondence relationships between the temperature of the second battery 3 and each threshold value (a first threshold value k1, a second threshold value k2, and a third threshold value k3 to be described below), or data of relational expressions indicating the correspondence relationships between the temperature of the second battery 3 and each threshold value.

Note that the temperature of the second battery 3 is not limited to a temperature detected by a sensor such as the BMU, and may also be a temperature estimated from the outside air temperature or weather information. The threshold value setting unit 14 may set a threshold value based on a combination of the temperature of the second battery 3 and the charge amount (remaining capacity) of the first battery 2 or may set a threshold value based on a combination of the charge amount (remaining capacity) of the first battery 2 and the charge amount (remaining capacity) of the second battery 3.

The timer processing unit 15 performs processing relating to a timer, such as setting, activation, stopping of the timer.

The chargeability determination unit 16 performs processing of determining whether the second battery 3 can be charged based on the vehicle information, processing of transferring a determination result thereof to the lower-level control units, processing of transferring the threshold values set by the threshold value setting unit 14 to the lower-level control units, and the like.

The abnormality determination unit 17 performs processing of determining, among the first battery 2 and the second battery 3, that at least the second battery 3 is in an abnormal state.

The communication state detection unit 18 performs processing of detecting communication states between the upper-level control unit 10 and the lower-level control units.

The upper-level control unit 10 performs processing of determining whether the second battery 3 can be charged via the chargeability determination unit 16, based on a determination result of the abnormality determination unit 17 and a detection result of the communication state detection unit 18; control relating to the charging of the second battery 3 in accordance with the determination result; and the like. Note that detailed description of the control related to the charging of the first battery 2 in the battery control system 1 and the like is omitted.

In the following description, when particularly describing the plurality of lower-level control units 20 and 30 distinctively, the lower-level control unit 20 is notated as the first lower-level control unit 20 and the lower-level control unit 30 is notated as the second lower-level control unit 30.

The first lower-level control unit 20 has a microcomputer configuration and includes a processor, a memory, and the like. The first lower-level control unit 20 functions as a charge amount monitoring unit 21 and a charging necessity determination unit 22, through the processor loading and executing a program stored in the memory.

The charge amount monitoring unit 21 monitors the charge amount consisting of the SoC estimated from the voltage of the first battery 2 or calculated by integrating the current of the first battery 2 detected by the BMU. The charge amount monitoring unit 21 continuously monitors the charge amount of the first battery 2 while the first lower-level control unit 20 is awake and intermittently monitors the charge amount of the first battery 2 while the first lower-level control unit 20 is asleep. The charge amount of the first battery 2 may be calculated by the charge amount monitoring unit 21 or may be calculated by the BMU.

The charging necessity determination unit 22 determines whether the first battery 2 needs to be charged based on a monitoring result of the charge amount monitoring unit 21 and the like, and transfers information based on a determination result thereof to the upper-level control unit 10.

The second lower-level control unit 30 has a microcomputer configuration and includes a processor, a memory, and the like. The second lower-level control unit 30 functions as a charge amount monitoring unit 31 and a charging necessity determination unit 32, through the processor loading and executing a program stored in the memory.

The charge amount monitoring unit 31 monitors the charge amount consisting of the SoC estimated from the voltage of the second battery 3 or calculated by integrating the current of the second battery 3 detected by the BMU. The charge amount monitoring unit 31 continuously monitors the charge amount of the second battery 3 while the second lower-level control unit 30 is awake and intermittently monitors the charge amount of the second battery 3 while the second lower-level control unit 30 is asleep. The charge amount of the second battery 3 may be calculated by the charge amount monitoring unit 31 or may be calculated by the BMU.

The charging necessity determination unit 32 determines whether the second battery 3 needs to be charged based on a monitoring result of the charge amount monitoring unit 31 and the like, and transfers information (for example, a charge request) based on a determination result thereof to the upper-level control unit 10.

### 2. Operation of Battery Control System 1

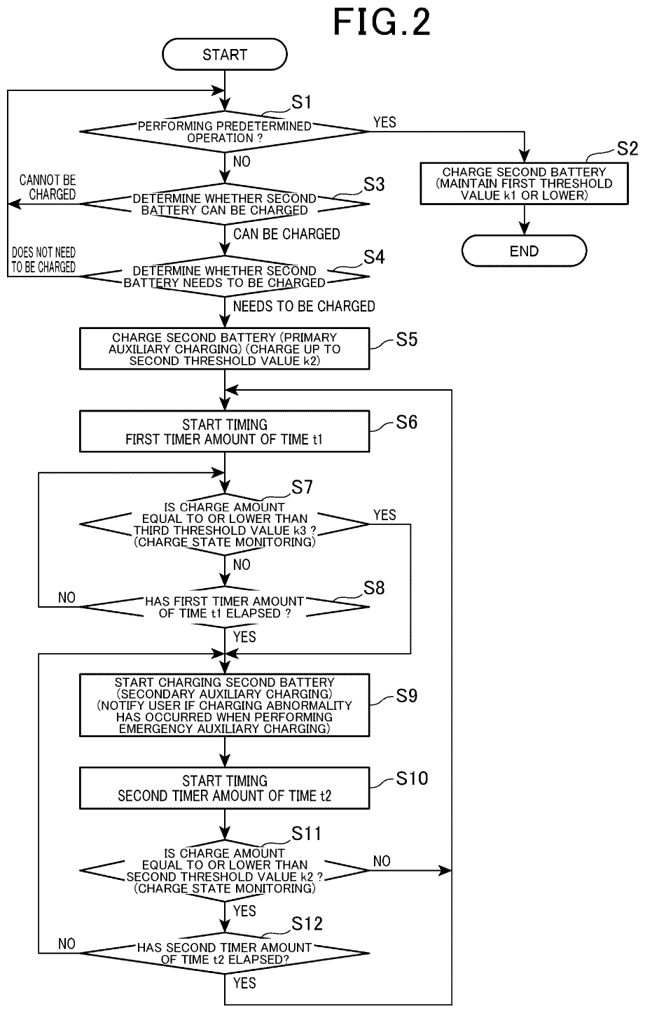

A battery control method will be described in accordance with a flowchart shown in FIG. 2. The battery control method in the present description is a control method relating to the charging of the second battery 3 and can be referred to as a battery charging method.

As shown in FIG. 2, the battery control unit 11 of the upper-level control unit 10 determines whether the vehicle is performing a predetermined operation, based on the vehicle information acquired by the vehicle information acquisition unit 13 (step S1).

The predetermined operation is an operation state in which charging can be performed immediately even when the charge amount of the second battery 3 is low. In the present embodiment, the predetermined operation includes the vehicle traveling, the first battery 2 being charged, and the electric power conversion unit 4 operating while the vehicle is stopped. When the vehicle is traveling, the first battery 2 is being charged, or the electric power conversion unit 4 is operating while the vehicle is stopped, the battery control unit 11 determines that the vehicle is performing the predetermined operation (YES in step S1).

When the vehicle is performing the predetermined operation (YES in step S1), the battery control unit 11 sets the first threshold value k1 via the threshold value setting unit 14, and controls the charging of the second battery 3 so that the charge amount of the second battery 3 does not exceed the first threshold value k1 based on the monitoring result of the second lower-level control unit 30 (step S2).

The first threshold value k1 is set to a value defining a charge amount that suppresses battery deterioration. The first threshold value k1 is used as a charge request possibility threshold value for determining whether the charge request is possible.

Lithium-ion batteries are typically known to easily deteriorate when being in a high-voltage state (high-state of charge (SoC) state) and a high-temperature state for a longer time. The first threshold value k1 of the present embodiment suppresses battery deterioration by being set to a value lower than a high SoC and a value equal to or higher than a charge amount at which activation of the vehicle can be ensured.

For example, when the temperature of the second battery 3 is 0° C. or higher, the first threshold value k1 is set to a value equal to or lower than a charge amount of 40%. When the temperature of the second battery 3 is 0° C. or less and exceeds −25° C., the first threshold value k1 is set to a value equal to or lower than a charge amount of 50%. When the temperature of the second battery 3 is −25° C. or less, the first threshold value k1 is set to a value equal to or lower than a charge amount of 60%.

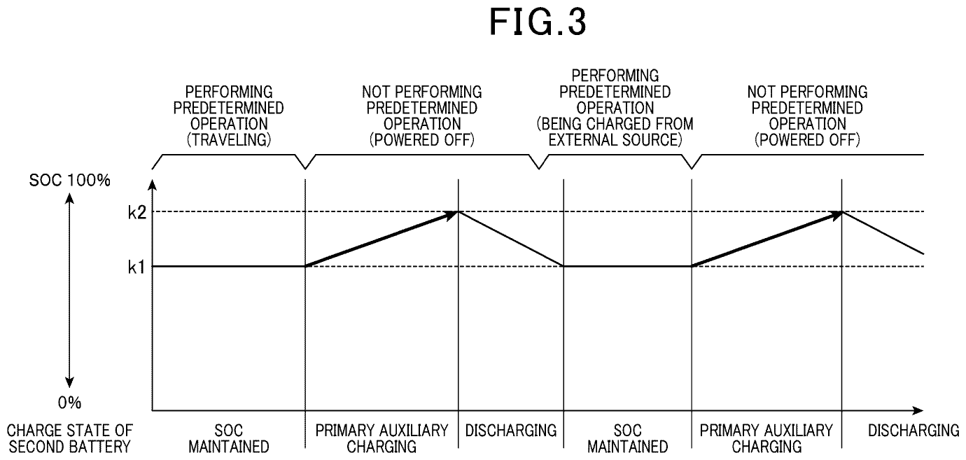

FIG. 3 is a diagram showing an example of a temporal change in the charge amount of the second battery 3. In FIG. 3, the vertical axis indicates the charge amount of the second battery 3 and the horizontal axis shows the time. Note that FIG. 3 shows a case in which the vehicle changes from traveling to being powered off (ignition turned off), to being charged from an external source (corresponding to the first battery 2 being charged), and then to being powered off again.

As shown in FIG. 3, the second battery 3 can be maintained at a charge amount corresponding to the first threshold value k1 (“SOC MAINTAINED” in FIG. 3), since the charging of the second battery 3 in step S2 is carried out during “TRAVELING” and “BEING CHARGED FROM EXTERNAL SOURCE” indicating that the vehicle is performing the predetermined operation.

When the vehicle is performing the predetermined operation, the second battery 3 does not have a high voltage (corresponding to high SoC), since the second battery 3 does not exceed the first threshold value k1. This makes it possible to suppress accelerated deterioration of the second battery 3. Since the second battery 3 is at a charge amount which ensures activation of the vehicle, it is possible to avoid a situation in which the activation of the vehicle is affected due to the second battery 3 being insufficiently charged.

Returned to FIG. 2, when it is determined that the vehicle is not performing the predetermined operation (NO in step S1), the battery control unit 11 determines whether the second battery 3 can be charged via the chargeability determination unit 16 (step S3).

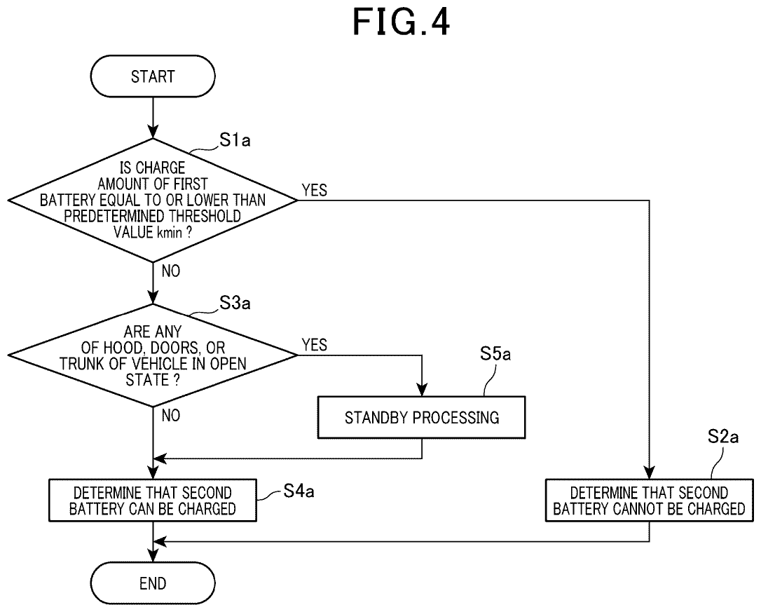

FIG. 4 is a diagram showing an example of determination processing in step S3.

As shown in FIG. 4, the chargeability determination unit 16 determines whether the charge amount of the first battery 2 is equal to or lower than the predetermined threshold value kmin, based on the monitoring result of the first lower-level control unit 20 (step S1a). The threshold value kmin is a value corresponding to a charge amount at a lower limit side of the first battery 2 without causing excessively affecting the traveling of the vehicle. In other words, the threshold value kmin is set to a value corresponding to a minimum charge amount of the first battery 2 that allows charging of the second battery 3 with the electric power of the first battery 2.

When the charge amount of the first battery 2 is equal to or lower than the threshold value kmin (YES in step S1a), the chargeability determination unit 16 determines that the second battery 3 cannot be charged (step S2a). Since it is determined that the second battery 3 cannot be charged, it is possible to avoid a situation in which the charge amount of the first battery 2 decreases excessively by charging the second battery 3.

When the charge amount of the first battery 2 is equal to or lower than the threshold value kmin, the battery control unit 11 does not carry out primary auxiliary charging and secondary auxiliary charging to be described below, since the charging of the second battery 3 not being performed. This makes it possible to avoid a situation in which the charge amount of the first battery 2 decreases excessively due to auxiliary charging.

When the charge amount of the first battery 2 exceeds the threshold value kmin (NO in step S1a), the chargeability determination unit 16 determines, based on the vehicle information, whether any of the hood, the doors, or the trunk of the vehicle are put in an open state within a predetermined period of time after the vehicle is powered off (step S3a). When any of the hood, the doors, or the trunk are not in an open state (NO in step S3a), the chargeability determination unit 16 determines that the second battery 3 can be charged (step S4a).

However, when any of the hood, the doors, or the trunk are in an open state (YES in step S3a), the chargeability determination unit 16 determines that the second battery 3 can be charged (step S4a) after standing by for a predetermined amount of standby time (step S5a).

The predetermined period of time in step S3a and the amount of standby time in step S5a are set to be sufficiently long enough for a user (for example, a driver), a worker, or the like to open any of the hood, the doors, or the trunk; access an interior of the vehicle; and perform predetermined work, such as inspecting the vehicle, checking the vehicle, replacing a part, or repairing the vehicle, after the predetermined operation of the vehicle ends (for example, after ignition is turned off).

The chargeability determination unit 16 also determines that the second battery 3 cannot be charged in the following cases 1 to 4:
1) When a period of time in which the vehicle is left unused (for example, a continued duration of the vehicle being powered off) is equal to or longer than a predetermined period of time (for example, 90 days).
2) When a malfunction is detected in a high-voltage system (including the first battery 2).
3) When a malfunction is detected in the second battery 3.
4) When a malfunction is detected in a timer function of the upper-level control unit 10.

Since the upper-level control unit 10 does not determine that the second battery 3 can be charged for the predetermined period of time and the amount of standby time, it is possible to avoid a situation in which the charging of the second battery 3 hinders the predetermined work. This makes it possible to avoid a situation in which replacement work of the second battery 3, measuring work of the second battery 3 by a tester, and the like are affected.

Returning to FIG. 2, when the chargeability determination unit 16 determines that the second battery 3 cannot be charged (CANNOT BE CHARGED in step S3), the battery control method transitions to the processing of step S1.

However, when the chargeability determination unit 16 determines that the second battery 3 can be charged, the second lower-level control unit 30 determines whether the second battery 3 needs to be charged via the charging necessity determination unit 32 (step S4).

The charging necessity determination unit 32 determines, based on the charge amount of the second battery 3 and the like, whether a condition is fulfilled in which the second battery 3 can be charged and the charge amount of the second battery 3 is equal to or lower than the first threshold value k1. The charging necessity determination unit 32 determines that the second battery 3 needs to be charged when this condition is fulfilled (CHARGING NECESSARY in step S4) and determines that the second battery 3 does not need to be charged when this condition is not fulfilled (CHARGING NOT NECESSARY in step S4).

When the charging necessity determination unit 32 determines that the second battery 3 needs to be charged, the charging necessity determination unit 32 transfers a charge request to the upper-level control unit 10.

When transferred content such as the charge request is not accepted by the upper-level control unit 10 for some reason, the charging necessity determination unit 32 retries transferring the charge request at a predetermined interval. As a result of the retrying, when the upper-level control unit 10 does not accept the transferred content and the charge amount of the second battery 3 becomes equal to or lower than a predetermined threshold value, processing of notifying the user of the vehicle thereof is preferably performed.

When it is determined that the second battery 3 does not need to be charged, the battery control unit 11 transitions to the processing of step S1. However, when it is determined that the second battery 3 needs to be charged, that is, when a charge request is transferred to the upper-level control unit 10, the battery control unit 11 transitions to the processing of step S5.

In step S5, the battery control unit 11 sets the second threshold value k2 that is higher than the first threshold value k1 via the threshold value setting unit 14, and controls the charging of the second battery 3 so that the charge amount of the second battery 3 does not exceed the second threshold value k2 based on the monitoring result of the second lower-level control unit 30. With this, as shown in FIG. 3, the second battery 3 is charged up to the second threshold value k2 when the predetermined operation ends and power is turned off (ignition is turned off). The charging in step S5 corresponds to “primary auxiliary charging of the second battery 3”.

By performing primary auxiliary charging of the second battery 3, it is possible to avoid a situation in which the charge amount of the second battery 3 decreases excessively even when the charge amount of the second battery 3 decreases due to dark current, actuation of auxiliary equipment, or the like when power is turned off after the predetermined operation ends and the like. Since the second battery 3 is used for activation of the vehicle, it is possible to avoid a situation in which the activation of the vehicle is affected.

“DISCHARGING” in FIG. 3 and each diagram to be described below indicates a case in which the charge amount of the second battery 3 is decreasing due to dark current and the like. The second threshold value k2 is a value that is higher than the first threshold value k1, and is set to a value for avoiding auxiliary charging as much as possible after the primary auxiliary charging while suppressing battery deterioration.

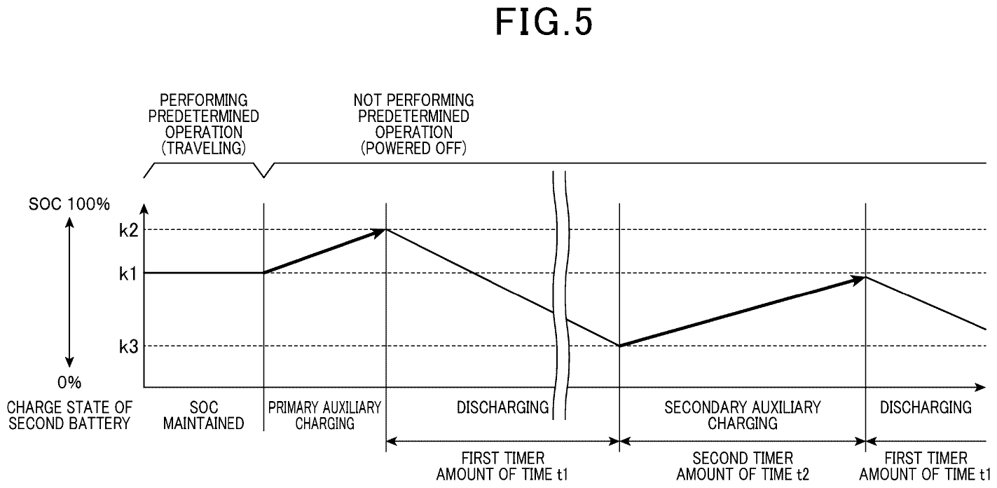

As shown in FIG. 2, after performing the primary auxiliary charging of the second battery 3 (step S5), the battery control unit 11 sets the third threshold value k3 (FIG. 5) that is lower than the first threshold value k1 via the threshold value setting unit 14. The battery control unit 11 then, via the timer processing unit 15, calculates a first timer amount of time t1 corresponding to an estimated amount of time during which the charge amount of the second battery 3 falls from a current value to a value equal to or lower than the third threshold value k3 and starts timing the first timer amount of time t1 (step S6).

The third threshold value k3 is a value that is lower than the first threshold value k1, and is set to a value that is within a range in which the charge amount of the second battery 3 ensures activation of the vehicle. The first timer amount of time t1 is set to an amount of time for which discharging is taken into consideration due to dark current at least during when the vehicle is left unused and the like.

Note that the first timer amount of time t1 may be set based on information obtained from a server or the like, the information being electric power information necessary for communication scheduled to be performed while the vehicle is parked or the like. Alternatively, the first timer amount of time t1 may be set based on a combination of information obtained from a server or the like and the charge amount (remaining capacity) of the second battery 3.

The second lower-level control unit 30 determines whether the charge amount of the second battery 3 is equal to or lower than the third threshold value k3, based on the monitoring result of the charge amount monitoring unit 31 (step S7). The battery control unit 11 determines whether the first timer amount of time t1 has elapsed (step S8).

When the charge amount of the second battery 3 is equal to or lower than the third threshold value k3 (YES in step S7) or when the first timer amount of time t1 has elapsed (YES in step S8), the battery control unit 11 controls the charging of the second battery 3 (step S9). The charging in step S9 corresponds to “secondary auxiliary charging of the second battery 3”.

FIG. 5 is a diagram showing another example of a temporal change in the charge amount of the second battery 3. FIG. 5 shows a case in which a state in which power is turned off continues for a longer period of time as opposed to the case shown in FIG. 3. The example shown in FIG. 5 shows a case in which the charge amount of the second battery 3 reaches the third threshold value k3 at a timing at which the first timer amount of time t1 elapses, as estimated by the timer processing unit 15.

As shown in FIG. 5, since the secondary auxiliary charging of the second battery 3 is performed at the timing at which the first timer amount of time t1 elapses, a situation is avoided in which the charge amount of the second battery 3 falls below the third threshold value k3 even when the second battery 3 is discharged due to dark current and the like. Thus, it is possible to perform auxiliary charging of the second battery 3 while suppressing battery deterioration due to excessive charging.

Returning to FIG. 2, in step S9, the battery control unit 11 starts charging the second battery 3 so that the charge amount of the second battery 3 does not exceed the first threshold value k1, based on the monitoring result of the second lower-level control unit 30. Since the first threshold value k1 is a value within a range in which the charge amount does not accelerate deterioration of the second battery 3 and is a value within a range in which the charge amount of the second battery 3 ensures activation of the vehicle, it is possible to avoid a situation in which the activation of the vehicle is affected while suppressing deterioration of the second battery 3.

However, the charge amount of the second battery 3 may fall to the third threshold value k3 at a timing earlier than the timing at which the first timer amount of time t1 elapses, due to a use environment of the vehicle, a deterioration state of the second battery 3, individual differences in the second battery 3, and the like.

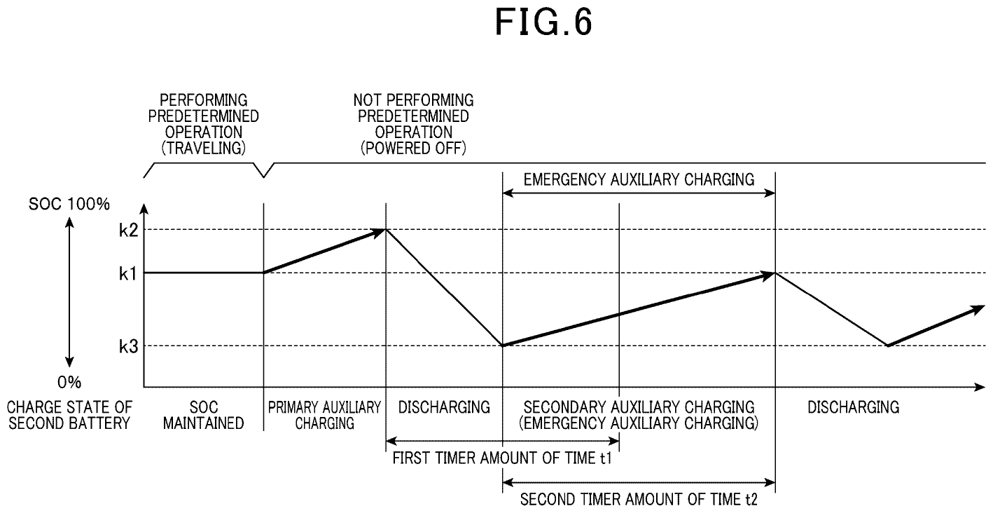

An example of a temporal change in the charge amount of the second battery 3 in this case is shown in FIG. 6.

As shown in FIG. 2 and FIG. 6, when the vehicle is not performing the predetermined operation, secondary auxiliary charging of the second battery 3 is force started through the processing of step S9 even when the first timer amount of time t1 has not elapsed, upon the charge amount of the second battery 3 becoming equal to or lower than the third threshold value k3 (YES in step S7).

Force charging the second battery 3 before the first timer amount of time t1 elapses corresponds to “EMERGENCY AUXILIARY CHARGING” (see FIG. 6).

When the emergency auxiliary charging is started, the battery control unit 11 determines whether a charging abnormality has occurred in the second battery 3 via the abnormality determination unit 17. In this case, the battery control unit 11 performs processing of notifying the user of the vehicle of the charging abnormality. Known processing is broadly applicable to the processing of determining the charging abnormality. For example, a method may be used of determining that a charging abnormality has occurred when the voltage or the charge amount of the second battery 3 does not increase normally even after charging. Alternatively, a method may be used of counting the number of emergency auxiliary charges and determining that a charging abnormality has occurred when this number exceeds a predetermined percentage of the total number of charges or the number of charges within a predetermined period of time.

Known processing is also broadly applicable to the processing of notifying the user of the vehicle of the charging abnormality and the like. For example, it is sufficient to apply the known processing to processing of, for example, transmitting notification information to a display device included in the vehicle, a user terminal carried by the user, or the like.

When performing the emergency auxiliary charging, it is possible that the second battery 3 does not have appropriate performance. This is, for example, in a case in which the second battery 3 has deteriorated and sufficient voltage, capacity, and the like of the second battery 3 cannot be sustained, or a case in which the second battery 3 is replaced with a battery having low performance. In the case of such a second battery 3, it is possible to swiftly notify the user of a charging abnormality, since it is determined a charging abnormality has occurred. In the present embodiment, it is possible to suppress excessively notifying the user while enhancing user-friendliness, since it is determined whether a charging abnormality has occurred in the second battery 3 when the predetermined percentage of the number of charges within the predetermined period of time is exceeded, and the user is notified in accordance with a determination result.

As shown in FIG. 2, when starting the secondary auxiliary charging of the second battery 3 (step S9), the battery control unit 11 sets a second timer amount of time t2 defining a maximum amount of time of the secondary auxiliary charging and starts timing the second timer amount of time t2 via the timer processing unit 15 (step S10). The battery control unit 11 determines whether the charge amount of the second battery 3 is equal to or lower than the second threshold value k2, based on the monitoring result of the second lower-level control unit 30 (step S11). When the charge amount is equal to or lower than the second threshold value k2 (YES in step S11) and the second timer amount of time t2 has not elapsed (NO in step S12), the battery control unit 11 transitions to the processing of step S9 and continues the secondary auxiliary charging.

When the charge amount reaches the second threshold value k2 through the secondary auxiliary charging (NO in step S11), the battery control unit 11 stops the secondary auxiliary charging and transitions to the processing of step S8. With this, as shown in FIG. 5 and FIG. 6, the charging of the second battery 3 is not restarted after the secondary auxiliary charging until the charge amount of the second battery 3 is equal to or lower than the third threshold value k3, when the state in which the vehicle is not performing the predetermined operation continues. According to the above operation, as shown in FIG. 5 and FIG. 6, the charge amount of the second battery 3 is maintained between the second threshold value k2 and the third threshold value k3 while the vehicle is not performing the predetermined operation.

The above operation is implemented due to the upper-level control unit 10 and the second lower-level control unit 30 operating in cooperation with each other.

As described above, the communication state detection unit 18 detects the communication state between the upper-level control unit 10 and the second lower-level control unit 30. When the communication state detection unit 18 detects an abnormality in the communication state between the upper-level control unit 10 and the second lower-level control unit 30, the upper-level control unit 10 charges, via the battery control unit 11, the second battery 3 during a preset timer amount of time without carrying out charging control of the second battery 3 based on a charge request from the second lower-level control unit 30.

When a communication abnormality occurs between the upper-level control unit 10 and the second lower-level control unit 30, charging control of the second battery 3 using the monitoring result of the lower-level control units and the like can no longer be carried out. In the present embodiment, when a communication abnormality occurs, it is possible to prevent a situation in which the charge amount of the second battery 3 decreases excessively and the vehicle can no longer move, since the second battery 3 is charged during the timer amount of time preset at the upper-level control unit 10 side.

The abnormality determination unit 17 counts the number of charges based on the charge request from the lower-level control unit, and determines that an abnormality has occurred in the second battery 3 when the number of charges exceeds a predetermined value. When charging is carried out at a high frequency within a predetermined period of time, it is possible to easily detect an abnormality in the second battery 3 by determining an abnormal state has occurred based on the number of charges within the predetermined period of time based on the charge request, since there is a high possibility of an abnormality (including battery lifespan) occurring in the second battery 3.

When an abnormality is detected in the second battery 3, the battery control unit 11 performs processing of notifying the user of the vehicle of the abnormality in the second battery 3. Known processing is broadly applicable to the processing of notifying the user. For example, it is sufficient to apply the known processing to processing of, for example, transmitting notification information to a display device included in the vehicle, a user terminal carried by the user, or the like. The known processing of transmitting notification information to a display device included in the vehicle, a user terminal carried by the user, or the like is applicable to the processing of notifying the user.

### 3. Threshold Value Setting Unit 14

As described above, the threshold value setting unit 14 sets the first threshold value k1 defining a charge amount that suppresses battery deterioration, the second threshold value k2 that is a higher value than the first threshold value k1 and suppresses battery deterioration, and the third threshold value k3 that is a value lower than the first threshold value k1 and ensures activation of the vehicle.

The first threshold value k1 is preferably set to a suitable value within a range in which the charge amount does not accelerate deterioration of the second battery 3 and within a range in which the charge amount ensures activation of the vehicle. In the present embodiment, a more appropriate first threshold value k1 can be set, since the first threshold value k1 is set based on the temperature of the second battery 3. For example, the first threshold value k1 is set to a relatively low value when the second battery 3 is in a high-temperature state and the first threshold value k1 is set to a relatively high value when the second battery 3 is in a low-temperature state. This makes it possible to set a threshold value for avoiding auxiliary charging as much as possible while suppressing battery deterioration while the vehicle is carrying out the predetermined operation.

The second threshold value k2 is a value that is higher than the first threshold value k1, and is preferably set to a value for avoiding auxiliary charging as much as possible after the primary auxiliary charging while suppressing battery deterioration. In the present embodiment, a more appropriate second threshold value k2 can be set, since the second threshold value k2 is set based on the temperature of the second battery 3. For example, the second threshold value k2 is set to a relatively low value when the second battery 3 is in a high-temperature state and the second threshold value k2 is set to a relatively high value when the second battery 3 is in a low-temperature state. This makes it possible to set a threshold value for avoiding auxiliary charging as much as possible while suppressing battery deterioration after the vehicle ends the predetermined operation.

The third threshold value k3 is a value that is lower than the first threshold value k1, and is preferably set to a value that is within a range in which the charge amount of the second battery 3 ensures activation of the vehicle and to a value for avoiding secondary auxiliary charging as much as possible. In the present embodiment, a more appropriate third threshold value k3 can be set, since the third threshold value k3 is set based on the temperature of the second battery 3. For example, the third threshold value k3 is set to a relatively low value when the second battery 3 is equal to or higher than a normal temperature and the third threshold value k3 is set to a relatively high value when the second battery 3 is in a low-temperature state. This makes it possible to set a threshold value for avoiding auxiliary charging as much as possible as well as ensuring activation of the vehicle. Note that the third threshold value k3 may be set based on a state of health (SoH) of the second battery 3.

### 4. Effects of Charging Control Related to Suppressing Deterioration of Second Battery 3

As described above, the battery control system 1 according to the present embodiment includes the battery control unit 11 that controls charging of the first battery 2 and the second battery 3, and the charge amount monitoring unit 31 that functions as a battery monitoring unit for monitoring the charge amounts of the first battery 2 and the second battery 3. When the vehicle is carrying out the predetermined operation, the battery control unit 11 charges the second battery 3 so that the charge amount of the second battery 3 does not exceed the first threshold value k1 for suppressing battery deterioration, based on the monitoring result of the charge amount monitoring unit 31. When the vehicle ends the predetermined operation, the battery control unit 11 carries out primary auxiliary charging for charging the second battery 3 up to the second threshold value k2 that is higher than the first threshold value k1.

According to this configuration, it is possible to ensure a charge amount of the second battery 3 for which power consumption due to dark current, using the battery, and the like is taken into consideration after the predetermined operation is ended, as well as suppressing deterioration of the second battery 3. This makes it possible to both suppress battery deterioration and ensure an appropriate charge amount.

The predetermined operation includes at least one of the vehicle traveling, the first battery 2 being charged, or the electric power conversion unit 4 operating while the vehicle is parked.

According to this configuration, in the case of at least one of the vehicle traveling, the first battery 2 being charged, or the electric power conversion unit 4 operating while the vehicle is parked, it is possible to immediately perform auxiliary charging of the second battery 3 up to the first threshold value k1 even when the charge amount of the second battery 3 is low and ensure an appropriate charge amount while suppressing deterioration of the second battery 3.

After carrying out the primary auxiliary charging, the battery control unit 11 measures the first timer amount of time t1 being the estimated amount of time during which the charge amount of the second battery 3 becomes equal to or lower than the third threshold value k3 that is lower than the first threshold value k1, and carries out secondary auxiliary charging of the second battery 3 when the first timer amount of time t1 has elapsed or when the charge amount has decreased to the third threshold value k3 before the first timer amount of time t1 elapses, based on the monitoring result of the charge amount monitoring unit 31. According to this configuration, it is possible to recharge the second battery 3 after the first timer amount of time t1 has elapsed even when the charge amount of the second battery 3 is affected by dark current and the like and decreases, after carrying out the primary auxiliary charging. This makes it possible to charge the second battery 3 while suppressing battery deterioration due to excessive charging. Calculating the first timer amount of time t1 is easy, by setting the first timer amount of time t1 based on the charge amount of the second battery.

As another aspect, the first timer amount of time t1 may be set based on information obtained from a server or the like, the information being electric power information necessary for communication scheduled to be performed while the vehicle is parked. Alternatively, the first timer amount of time t1 may be set based on a combination of information obtained from a server and the charge amount of the second battery 3. Out-of-vehicle communication consumes electric power of the second battery 3, and the amount of electric power used may increase in communication such as telematics. Thus, it is possible to prevent depleting the second battery 3 while maintaining necessary communication, by setting the first timer amount of time t1 based on information obtained from a server or setting the first timer amount of time t1 based on a combination of information obtained from a server and the charge amount of the second battery 3.

The battery control unit 11 carries out, before the first timer amount of time t1 elapses, the above-described secondary auxiliary charging as the emergency auxiliary charging, when detecting that the charge amount of the second battery 3 is equal to or lower than the third threshold value k3, based on the monitoring result of the charge amount monitoring unit 31.

According to this configuration, it is possible to immediately performing charging and avoid a situation in which activation of the vehicle and the like is affected, when the charge amount of the second battery 3 falls to a value equal to or lower than the third threshold value k3 at a timing earlier than the first timer amount of time t1 due to the use environment, state, or the like of the second battery 3.

When having carried out the emergency auxiliary charging, the battery control unit 11 determines whether a charging abnormality has occurred in the second battery 3 based on information about the second battery 3 and performs processing of notifying the user of the vehicle of the charging abnormality based on a determination result.

According to this configuration, it is possible that the second battery 3 does not have suitable performance when carrying out emergency auxiliary charging, and a case in which the second battery 3 has deteriorated and sufficient voltage, capacity, and the like of the second battery 3 cannot be sustained, a case in which the second battery 3 is replaced with a battery having low performance, or the like can be considered. In the case of such a battery, it is possible to enhance user-friendliness by notifying the user and suppress excessively notifying the user, since it is possible to determine a charging abnormality has occurred.

When the charge amount of the first battery 2 is equal to or lower than the predetermined threshold value kmin, the battery control unit 11 does not carry out primary auxiliary charging of the second battery 3.

According to this configuration, it is possible to avoid a situation in which the charge amount of the first battery 2 decreases excessively due to auxiliary charging of the second battery 3, and appropriate charging control becomes possible in accordance with the circumstances the vehicle is in.

When the charge amount of the first battery 2 is equal to or lower than the predetermined threshold value kmin, the battery control unit 11 does not carry out secondary auxiliary charging of the second battery 3.

According to this configuration, it is possible to suppress a situation in which the charge amount of the first battery 2 decreases excessively due to auxiliary charging of the second battery 3, and appropriate charging control becomes possible in accordance with the circumstances the vehicle is in.

The battery control system 1 includes the vehicle information acquisition unit 13 that acquires the vehicle information. The vehicle information includes the open/closed state of at least one opening/closing member among the hood, the doors, or the trunk of the vehicle. The battery control unit 11 does not carry out primary auxiliary charging until the predetermined amount of standby time elapses, when the opening/closing member is put in the open state within the predetermined period of time after the vehicle is powered off.

According to this configuration, it is possible to avoid a situation in which performing auxiliary charging of the second battery 3 hinders work on the vehicle, and to enhance maintenance of the vehicle.

### 5. Effects of Cooperation Control Related to Second Battery 3

The battery control system 1 according to the present embodiment includes the upper-level control unit 10 that controls charging of the first battery 2 and the second battery 3, and the second lower-level control unit 30 that monitors the second battery 3. The upper-level control unit 10 includes the battery information acquisition unit 12 that acquires the battery information relating to the batteries 2 and 3, the vehicle information acquisition unit 13 that acquires the vehicle information relating to the vehicle, the threshold value setting unit 14 that sets the threshold value defining the charge amount of the second battery 3 based on the battery information, and the chargeability determination unit 16 that determines whether the second battery 3 can be charged based on the vehicle information and transfers the determination result and the threshold value to the second lower-level control unit 30. The second lower-level control unit 30 includes the charge amount monitoring unit 31 that monitors the charge amount of the second battery 3, and the charging necessity determination unit 32 that transfers a charge request for the second battery 3 to the upper-level control unit 10 when the above-described determination result indicates that the second battery 3 can be charged and the charge amount is equal to or lower than the threshold values k1 and k2.

According to this configuration, since processing of monitoring the second battery 3 and determining whether the second battery 3 needs to be charged is performed in the second lower-level control unit 30, it is possible to reduce the time and electric power needed for this processing more than when the upper-level control unit 10 performs the processing. Since processing related to cooperation control of the upper-level control unit 10 and the second lower-level control unit 30 for setting the threshold values k1 and k2 and the like is performed in the upper-level control unit 10, it is possible to efficiently perform the setting of appropriate threshold values k1 and k2. This makes it possible to accelerate and lower power consumption of control related to battery charging and ensure an appropriate charge amount of the battery.

The battery information includes the temperature of the second battery 3, and the threshold value setting unit 14 sets the threshold values k1 and k2 based on the temperature of the second battery 3.

According to this configuration, it is easier to set a threshold value for ensuring an appropriate charge amount without performing auxiliary charging as much as possible, by setting the threshold values k1 and k2 based on the temperature of the second battery 3, since the appropriate charge amount differs depending on the temperature of the second battery 3.

The second lower-level control unit 30 monitors whether the charge amount of the second battery 3 is equal to or lower than the third threshold value k3 via the charge amount monitoring unit 31 when the second battery 3 is not being charged, and transfers a charge request for the second battery 3 to the upper-level control unit 10 via the charging necessity determination unit 32 when the charge amount is equal to or lower than the third threshold value k3. It is easier for the threshold value setting unit 14 to set a threshold value for ensuring an appropriate charge amount without performing auxiliary charging as much as possible as well as ensuring activation of the vehicle, by setting the threshold value k3 based on the temperature of the second battery 3.

In the upper-level control unit 10, the vehicle information includes the open/closed state of at least one opening/closing member among the hood, the doors, or the trunk of the vehicle; and the chargeability determination unit 16 does not determine that the second battery 3 can be charged until the predetermined amount of standby time elapses, when the opening/closing member is put in the open state within the predetermined period of time after the vehicle ends a predetermined operation.

According to this configuration, it is possible to avoid a situation in which performing charging of the second battery 3 hinders work on the vehicle, and to enhance maintenance of the vehicle.

The predetermined operation includes at least one of the mobile body traveling, the first battery 2 being charged, or the electric power conversion unit 4 operating while the vehicle is stopped (parked).

According to this configuration, it is possible to avoid a situation in which performing charging of the second battery 3 hinders work on the vehicle and to enhance maintenance of the vehicle, when the opening/closing member is put in the open state after at least one of the vehicle traveling, the first battery 2 being charged, or the electric power conversion unit 4 operating while the vehicle is stopped.

The upper-level control unit 10 includes the communication state detection unit 18 that detects the communication state between the upper-level control unit 10 and the second lower-level control unit 30. The upper-level control unit 10 charges the second battery 3 during the preset timer amount of time without carrying out charging control of the second battery 3 based on a charge request from the second lower-level control unit 30, when the above-described communication state is abnormal.

According to this configuration, when a communication abnormality occurs between the upper-level control unit 10 and the second lower-level control unit 30, charging control of the second battery 3 using the monitoring result of the second lower-level control unit 30 and the like can no longer be carried out. When a communication abnormality occurs, it is possible to prevent a situation in which the vehicle can no longer move, by charging the second battery 3 during the timer amount of time preset at the upper-level control unit 10 side.

The charge amount monitoring unit 31 continuously monitors the charge amount of the second battery 3 while the second lower-level control unit 30 is awake and intermittently monitors the charge amount of the second battery 3 while the second lower-level control unit 30 is asleep.

According to this configuration, it becomes possible to manage the charge amount in real-time while the second lower-level control unit 30 is awake and to manage the charge amount with low power consumption while the second lower-level control unit 30 is asleep, thus enabling effective operation.

The upper-level control unit 10 includes the abnormality determination unit 17 that determines, among the first battery 2 and the second battery 3, that at least the second battery 3 is in an abnormal state. The abnormality determination unit 17 counts the number of charges within the predetermined period of time based on the charge request from the second lower-level control unit 30, and determines that an abnormality has occurred in the second battery 3 when the number of charges exceeds the predetermined value.

According to this configuration, when charging is carried out at a high frequency within the predetermined period of time, it is possible to easily detect an abnormality in the second battery 3 by determining an abnormal state has occurred based on the number of charges within the predetermined period of time based on the charge request, since there is a high possibility of an abnormality occurring in the battery.

Note that the processing of the battery control unit 11 can be referred to as a battery control step, the processing of the battery information acquisition unit 12 can be referred to as a battery information acquisition step, the processing of the vehicle information acquisition unit 13 can be referred to as a vehicle information acquisition step, the processing of the threshold value setting unit 14 can be referred to as a threshold value setting step, the processing of the timer processing unit 15 can be referred to as a timer processing step, the processing of the chargeability determination unit 16 can be referred to as a chargeability determination step, the processing of the abnormality determination unit 17 can be referred to as an abnormality determination step, the processing of the communication state detection unit 18 can be referred to as a communication state detection step, the processing of the charge amount monitoring unit 31 can be referred to as a charge amount monitoring step, and the processing of the charging necessity determination unit 32 can be referred to as a charging necessity determination step.

### Second Embodiment

In the technology described in U.S. Unexamined Patent Application Publication No. 2023/0144284, since the monitoring of the charge amount of the battery corresponding to the second battery 3 is carried out by the control unit at the upper-level side, the monitoring accuracy decreases due to the time lag, communication delay, or the like until the battery information from the control unit at the terminal side is transferred. Thus, the battery may become overdischarged at a timing earlier than an estimated timing of a power supply failure state (so-called battery exhaustion) due to low voltage of the battery predicted by the control unit at the upper-level side, which may lead to shortened battery life, battery replacement, or the like.

Hypothetically, even when notification processing of encouraging auxiliary charging, notification processing to a mobile terminal carried by the user (for example, the driver), or the like is performed in accordance with the estimated timing predicted, appropriate auxiliary charging may fail to be performed in time, leading to battery exhaustion.

In addition to the configuration described in the first embodiment, the battery control system 1 according to a second embodiment has the following configuration for reducing the time and electric power needed for interrupting an electric power supply from the second battery 3, in order to prevent an electric power supply failure state (battery exhaustion) due to low voltage of the second battery 3.

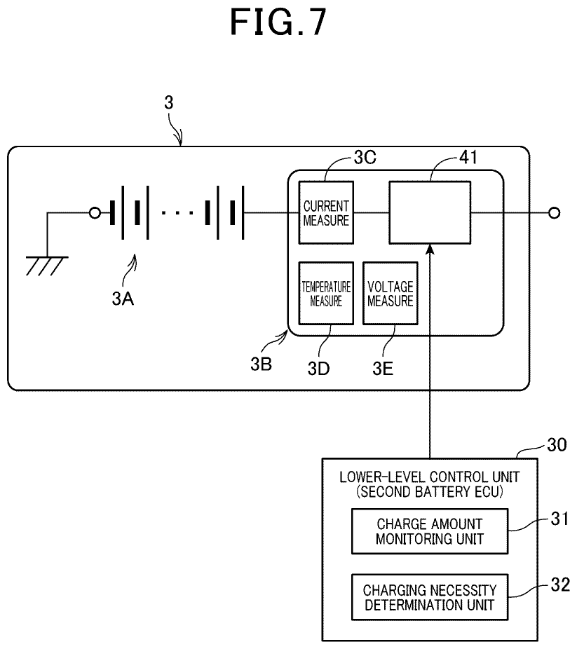

FIG. 7 is a diagram showing the second battery 3 and the second lower-level control unit 30.

As shown in FIG. 7, the second battery 3 includes a relay 41 that interrupts the electric power supply from the second battery 3. FIG. 7 shows a battery cell group 3A of the second battery 3 and a battery control substrate 3B constituting a BMU provided in the second battery 3. The relay 41 is provided on the battery control substrate 3B, and is controlled by the second lower-level control unit 30.

The battery control substrate 3B is provided with a current sensor 3C that measures a charge/discharge current of the second battery 3, a temperature sensor 3D that measures the temperature of the second battery 3, a voltage sensor 3E that measures the voltage of the second battery 3, and the like.

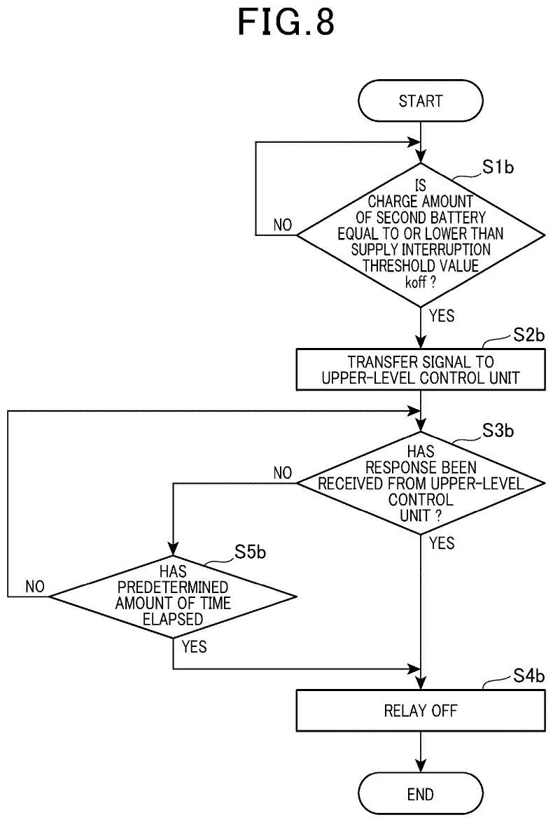

FIG. 8 is a flowchart showing control processing of the relay 41.

As shown in FIG. 8, the second lower-level control unit 30 determines, via the charging necessity determination unit 32, whether the charge amount of the second battery 3 is equal to or lower than a supply interruption threshold value koff, that is, whether the charge amount of the second battery 3 has decreased to reach the supply interruption threshold value koff (step S1b).

Here, the supply interruption threshold value koff is set to a value lower than the first threshold value k1 being the charge request possibility threshold value shown in FIG. 2, and is, for example, set to a value before an output voltage of the second battery 3 decreases down to a level that complicates starting, operation, and the like of the mobile body. The value of the supply interruption threshold value koff may be a fixed value set in advance, or may be set taking into consideration information acquired by the threshold value setting unit 14 from the BMU of the second battery 3.

When the charge amount of the second battery 3 has not reached the supply interruption threshold value koff (NO in step S1b), the second lower-level control unit 30 repeats the processing of step S1b at a predetermined interrupt cycle and continuously monitors whether the charge amount of the second battery 3 has reached the supply interruption threshold value koff.

When the charge amount of the second battery 3 reaches the supply interruption threshold value koff (YES in step S1b), the second lower-level control unit 30 transfers, via the charging necessity determination unit 32, a signal indicating that the supply interruption threshold value koff has been reached to the upper-level control unit 10 (step S2b).

After transferring the signal to the upper-level control unit 10, the second lower-level control unit 30 starts counting an elapsed time via the charging necessity determination unit 32. When the second lower-level control unit 30 receives a response from the upper-level control unit 10 (YES in step S3b), the second lower-level control unit 30 turns off the relay 41, interrupting the electric power supply from the second battery 3 (step S4b). That is, the second lower-level control unit 30 performs processing of transferring the signal to the upper-level control unit 10 and functions as a relay control unit that turns off the relay 41.

Note that a functional unit that functions as the relay control unit may be provided in the second lower-level control unit 30.

On the other hand, when the second lower-level control unit 30 does not receive the response from the upper-level control unit 10 (NO in step S3b), the second lower-level control unit 30 repeats the determination processing of step S3b until a predetermined amount of time elapses (NO in step S5b). When the predetermined amount of time elapses (YES in step S5b), the second lower-level control unit 30 executes the processing of step S4b.

In this way, when the charge amount of the second battery 3 reaches the supply interruption threshold value koff, the second lower-level control unit 30 immediately interrupts, via the relay 41, the electric power supply from the second battery 3 after notifying the upper-level control unit 10. With this, since it is possible to perform the monitoring of the charge amount of the second battery 3 and the relay control with the second lower-level control unit 30, it is possible to suppress the processing time needed for interrupting the electric power supply to a minimum and to decrease electric power consumption more than when the upper-level control unit 10 performs the processing. As a result, it is possible to appropriately manage the charge state of the second battery 3 and to suppress battery exhaustion due to a low charge amount. By notifying the upper-level control unit 10 and performing shutdown processing before interrupting the electric power supply from the second battery 3, it is possible to prevent malfunction of the upper-level control unit 10, since it becomes possible to prevent shutdown during processing of the program.

The second lower-level control unit 30 interrupts, via the relay 41, the electric power supply from the second battery 3 after notifying the upper-level control unit 10 that the supply interruption threshold value koff has been reached, when the response from the upper-level control unit 10 is received or when the predetermined amount of time elapses as a condition. This makes it possible to suppress a delay in the relay control even when a response delay of the upper-level control unit 10 occurs, and to suppress electric power consumption while preventing overdischarge of the second battery 3.

### Other Embodiments

The above-described embodiment is merely one embodiment according to the present invention and can be freely modified and applied without departing from the gist of the present invention.

For example, during nighttime in cold regions or in the winter, the temperature of the battery may fall below the freezing point, and detection accuracy of the charge amount of the battery decreases when the temperature of the battery is low.

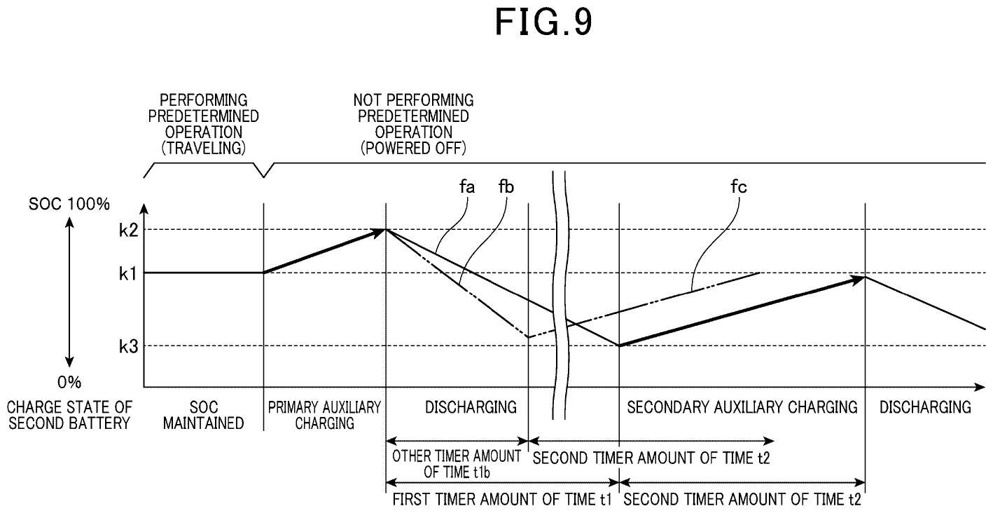

FIG. 9 is a diagram for describing a first modified example, and shows an example of a temporal change in the charge amount of the second battery 3 when the vehicle being powered off continues for a longer period of time as described in FIG. 5.

A solid line fa in FIG. 9 indicates a change characteristic of the actual charge amount of the second battery 3 detected when the temperature of the battery is in a temperature range in which the detection accuracy is relatively high. A dash-dotted line fb in FIG. 9 indicates a change characteristic of the actual charge amount of the second battery 3 detected when the temperature of the battery is in a temperature range in which the detection accuracy is relatively low when the vehicle is parked.

As shown in FIG. 9, the charge amount fb in a low temperature range is a value lower than the charge amount fa when not in a low temperature range. A situation may occur in which the actual charge amount of the second battery 3 decreases excessively and, for example, falls below the third threshold value k3.

A fixed timer amount of time t1b (see FIG. 9) is first set that is a timing earlier than a point in time when the charge amount of the second battery 3 decreases excessively (for example, a point in time when the charge amount becomes equal to or lower than the third threshold value k3), when the temperature is in a predetermined temperature range in which the detection accuracy of the charge amount of the second battery 3 is relatively low.

In the example shown in FIG. 9, the fixed timer amount of time t1b< the first timer amount of time t1 but is not limited thereto, and the fixed timer amount of time t1b> the first timer amount of time t1 may also hold true.

As shown in FIG. 9, when the temperature of the second battery 3 is in the predetermined temperature range in which the detection accuracy of the charge amount of the second battery 3 is relatively low after the auxiliary charging consisting of the primary auxiliary charging and the secondary auxiliary charging, the battery control unit 11 then carries out the secondary auxiliary charging of the second battery 3, as indicated by a dash-dot-dot line fc in FIG. 9, after a timer amount of time that is the shorter one of the first timer amount of time t1 or the fixed timer amount of time t1b elapses.

This makes it possible to force charge the second battery 3 before the charge amount decreases excessively, when the temperature is in a temperature range in which the detection accuracy of the charge amount of the second battery 3 is relatively low. This makes it possible to avoid a situation in which the charge amount of the second battery 3 decreases excessively, for example, to prevent battery exhaustion during cold periods.

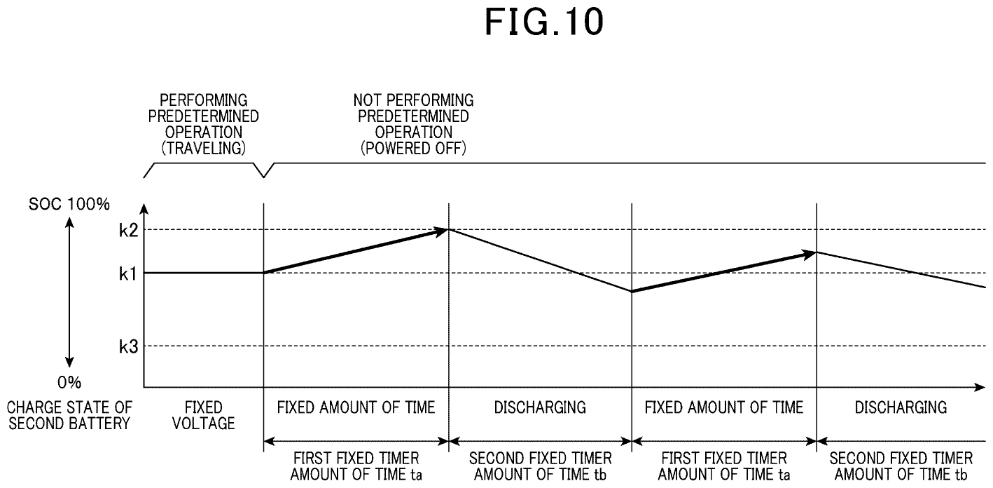

FIG. 10 is a diagram showing another example of a temporal change in the charge amount of the second battery 3 for describing a second modified example and a third modified example.

In the second modified example, the battery control unit 11 carries out fixed voltage charging of the second battery 3 as shown in FIG. 10, when the temperature of the second battery 3 is in the predetermined temperature range in which the detection accuracy of the charge amount of the second battery 3 is relatively low and the vehicle is carrying out the predetermined operation. The fixed voltage charging makes it possible to stabilize a charging state while suppressing voltage fluctuations in the second battery 3.

In the second modified example, the battery control unit 11 carries out charging of the second battery 3 during a preset first fixed timer amount of time ta as shown in FIG. 10, when the temperature of the second battery 3 is in the above predetermined temperature range and the mobile body has ended the predetermined operation. This makes it possible to ensure sufficient charge amount of the second battery 3 and to prevent a situation in which activation and the like of the vehicle is affected when the temperature is in the predetermined temperature range in which the detection accuracy of the charge amount of the second battery 3 is relatively low.

Subsequently, the battery control unit 11 carries out charging of the second battery 3 during the first fixed timer amount of time ta after a predetermined second fixed timer amount of time tb has elapsed after the first fixed timer amount of time ta has elapsed. In this manner, the charging during the first fixed timer amount of time ta and the not charging during the second fixed timer amount of time tb are repeated while the state in which the vehicle is not performing the predetermined operation continues as the temperature of the second battery 3 is in the above-described predetermined temperature range. By appropriately setting the first fixed timer amount of time ta and the second fixed timer amount of time tb, it is possible to ensure a sufficient charge amount and to prevent a situation in which activation and the like of the vehicle is affected as well as avoiding a situation in which the charge amount of the second battery 3 decreases excessively, without being dependent on the detected charge amount.

In the third modified example, the battery control unit 11 carries out the fixed voltage charging of the second battery 3 as shown in FIG. 10, when the communication state detection unit 18 detects that the communication state is abnormal and the vehicle is carrying out the predetermined operation. The fixed voltage charging makes it possible to stabilize the charging state while suppressing voltage fluctuations in the second battery 3.

In the third modified example, the battery control unit 11 carries out charging of the second battery 3 during the preset first fixed timer amount of time ta as shown in FIG. 10, when the communication state detection unit 18 detects that the communication state is abnormal and the vehicle has ended the predetermined operation. This makes it possible to ensure sufficient charge amount of the second battery 3 and to prevent a situation in which activation and the like of the vehicle is affected, when control based on the charge amount is no longer possible due to a communication abnormality.

In the above-described embodiment, when a situation occurs in which the second battery 3 cannot be charged such as a malfunction being detected at the first battery 2 side or an abnormality being detected by the abnormality determination unit 17, the communication state detection unit 18, or the like, a signal for prohibiting charging of the second battery 3 may be transferred from the upper-level control unit 10 side to the second lower-level control unit 30, and charging of the second battery 3 may be prohibited until a release signal is transmitted from the upper-level control unit 10 side to the second lower-level control unit 30.

In this case, for example, the battery control unit 11 may transfer the signal for prohibiting charging of the second battery 3 to the charge amount monitoring unit 31 functioning as the battery monitoring unit, and charging of the second battery 3 may be prohibited until the battery control unit 11 transmits the release signal to the charge amount monitoring unit 31.

The out-of-vehicle communication unit 5 may limit communication in accordance with a reason for not performing auxiliary charging, when the battery control unit 11 does not perform auxiliary charging. The reason for not performing auxiliary charging includes a case in which the charge amount of the first battery 2 is equal to or lower than a predetermined value, a case in which an opening/closing member such as the hood is put in an open state within the predetermined period of time after the vehicle is powered off, a case in which the charge amount of the first battery 2 is equal to or lower than the predetermined threshold value kmin, or the like.

Out-of-vehicle communication consumes electric power of the second battery 3, and the amount of electric power used may increase in communication such as telematics. As such, in an environment in which auxiliary charging cannot be performed, it is possible to prevent depletion of the second battery 3 while maintaining necessary communication, by limiting communication in accordance with the reason for prohibiting auxiliary charging, when the charge amount of the first battery 2 is equal to or lower than the predetermined value or the like.

The configuration of the battery control system 1 shown in FIG. 1 is one example and may be modified as appropriate. For example, the first battery 2 and the second battery 3 may be batteries other than lithium-ion batteries. The configuration of the battery control unit 11 and the like is not limited to being fully implemented inside the vehicle. For example, at least a part of the processing performed by the battery control unit 11 and the like may be implemented by a device outside of the vehicle such as a server.

FIG. 1 is a schematic diagram showing the configuration of the battery control system 1 divided according to main processing contents thereof in order to facilitate understanding of the invention of the present application, but the configuration of the battery control system 1 may be divided in a different manner. The processing of respective components may be executed by one hardware unit or may be executed by a plurality of hardware units. The processing of respective components may be executed by one program or may be executed by a plurality of programs.

A case has been described in which a program for realizing the battery control method according to the present invention is recorded on a memory included in the battery control system 1, but the program may be acquired from an external equipment via communication. The program may be recorded on a recording medium so as to be readable by a computer. A magneto-optical recording medium or a semiconductor memory device can be used for the recording medium.

### Configurations Supported by the Above-Described Embodiment

The following configurations are specific examples of the above embodiment.
(Configuration 1) A battery control system installed in a mobile body, the battery control system including: an upper-level control unit that controls charging of a first battery storing electric power for driving a power unit and a second battery charged with electric power of the first battery; and a lower-level control unit that monitors the second battery. The upper-level control unit includes: a battery information acquisition unit that acquires battery information relating to the first battery and the second battery; a mobile body information acquisition unit that acquires mobile body information relating to the mobile body; a threshold value setting unit that sets a threshold value defining a charge amount of the second battery, based on the battery information; and a chargeability determination unit that determines whether the second battery can be charged based on the mobile body information, and transfers a determination result and the threshold value to the lower-level control unit. The lower-level control unit includes: a charge amount monitoring unit that monitors the charge amount of the second battery; and a charging necessity determination unit that transfers a charge request for the second battery to the upper-level control unit, when the determination result indicates that the second battery can be charged and the charge amount is equal to or lower than the threshold value.

According to this configuration, since processing of monitoring the second battery and determining whether the second battery needs to be charged is performed in the lower-level control unit, it is possible to reduce the time and electric power needed for this processing more than when the upper-level control unit performs the processing. Since processing related to cooperation control with other control units for setting the threshold value and the like is performed in the upper-level control unit, it is possible to efficiently perform the setting of an appropriate threshold value and the like. This makes it possible to accelerate and lower power consumption of control related to battery charging and ensure an appropriate charge amount of the battery.
(Configuration 2) The battery control system according to configuration 1, wherein the battery information includes a temperature of the second battery, and the threshold value setting unit sets the threshold value based on the temperature.

According to this configuration, it is easier to set a threshold value for ensuring an appropriate charge amount without performing auxiliary charging as much as possible, by setting the threshold value based on the temperature of the second battery, since the appropriate charge amount differs depending on the temperature of the second battery.
(Configuration 3) The battery control system according to configuration 1 or 2, wherein the mobile body is a vehicle, the mobile body information includes an open/closed state of at least one opening/closing member among a hood, doors, or a trunk of the vehicle, and the chargeability determination unit does not determine that the second battery can be charged until a predetermined amount of standby time elapses, when the opening/closing member is put in an open state within a predetermined period of time after the vehicle ends a predetermined operation.

According to this configuration, it is possible to avoid a situation in which performing charging of the second battery hinders work on the vehicle, and to enhance maintenance of the vehicle.
(Configuration 4) The battery control system according to configuration 3, wherein the predetermined operation includes at least one of the vehicle traveling, the first battery being charged, or an electric power conversion unit converting electric power stored in the first battery to predetermined electric power while the vehicle is stopped.

According to this configuration, it is possible to avoid a situation in which performing charging of the second battery hinders work on the vehicle and to enhance maintenance of the vehicle, when the opening/closing member is put in the open state after at least one of the vehicle traveling, the first battery being charged, or the electric power conversion unit operating while the vehicle is stopped.
(Configuration 5) The battery control system according to any one of configurations 1 to 4, further including a communication state detection unit that detects a communication state between the upper-level control unit and the lower-level control unit, wherein the upper-level control unit charges the second battery during a preset timer amount of time without carrying out charging control of the second battery based on the charge request, when the communication state is abnormal.

According to this configuration, when a communication abnormality occurs between the upper-level control unit and the lower-level control unit, charging control of the second battery using the monitoring result of the lower-level control unit and the like can no longer be carried out. When a communication abnormality occurs, it is possible to prevent a situation in which the vehicle can no longer move, by charging the second battery during the timer amount of time preset at the upper-level control unit side.
(Configuration 6) The battery control system according to any one of configurations 1 to 5, wherein the charge amount monitoring unit continuously monitors the charge amount while the lower-level control unit is awake and intermittently monitors the charge amount while the lower-level control unit is asleep.

According to this configuration, it becomes possible to manage the charge amount in real-time while the lower-level control unit is awake and to manage the charge amount with low power consumption while the lower-level control unit is asleep, thus enabling effective operation.
(Configuration 7) The battery control system according to any one of configurations 1 to 6, wherein the upper-level control unit includes an abnormality determination unit that determines, among the first battery and the second battery, that at least the second battery is in an abnormal state, and the abnormality determination unit counts the number of charges within a predetermined period of time based on the charge request, and determines that an abnormality has occurred in the second battery when the number of charges exceeds a predetermined value.

According to this configuration, when charging is carried out at a high frequency within the predetermined period of time, it is possible an abnormality has occurred in the battery. Thus, it is possible to easily detect an abnormality in the second battery by determining an abnormal state has occurred based on the number of charges within the predetermined period of time based on the charge request.
(Configuration 8) The battery control system according to any one of Configurations 1 to 7, further including a relay that interrupts an electric power supply from the second battery, wherein when the charge amount of the second battery reaches a supply interruption threshold value lower than the threshold value, the lower-level control unit interrupts, via the relay, the electric power supply from the second battery after notifying the upper-level control unit that the supply interruption threshold value has been reached.

According to this configuration, since it is possible to perform the monitoring of the charge amount of the second battery and the relay control with the lower-level control unit, it is possible to suppress the processing time needed for interrupting the electric power supply to a minimum and to decrease electric power consumption more than when the upper-level control unit performs the processing, because the monitoring of the charge amount of the second battery and the relay control is performed with the lower-level control unit.
(Configuration 9) The battery control system according to Configuration 8, wherein the lower-level control unit interrupts, via the relay, the electric power supply from the second battery after notifying the upper-level control unit that the supply interruption threshold value has been reached, when a response from the upper-level control unit is received or when a predetermined amount of time elapses as a condition.

According to this configuration, it is possible to suppress a delay in the relay control even when a response delay of the upper-level control unit occurs, and to suppress electric power consumption while preventing overdischarge of the second battery.
(Configuration 10) A battery control method executed by a mobile body, the mobile body including: an upper-level control unit that controls charging of a first battery storing electric power for driving a power unit and a second battery charged with electric power of the first battery; and a lower-level control unit that monitors the second battery. The upper-level control unit executes: a battery information acquisition step of acquiring battery information relating to the first battery and the second battery; a mobile body information acquisition step of acquiring mobile body information relating to the mobile body; a threshold value setting step of setting a threshold value defining a charge amount of the second battery, based on the battery information; and a chargeability determination step of determining whether the second battery can be charged based on the mobile body information, and transferring a determination result and the threshold value to the lower-level control unit. The lower-level control unit executes: a charge amount monitoring step of monitoring the charge amount of the second battery; and a charging necessity determination step of transferring a charge request for the second battery to the upper-level control unit, when the determination result indicates that the second battery can be charged and the charge amount is equal to or lower than the threshold value.

According to this method, since processing of monitoring the second battery and determining whether the second battery needs to be charged is performed in the lower-level control unit, it is possible to reduce the time and electric power needed for this processing more than when the upper-level control unit performs the processing. Since processing related to cooperation control with other control units for setting the threshold value and the like is performed in the upper-level control unit, it is possible to efficiently perform the setting of an appropriate threshold value and the like. This makes it possible to accelerate and lower power consumption of control related to battery charging and ensure an appropriate charge amount of the battery.
(Configuration 11) The battery control method according to Configuration 10, wherein when the charge amount of the second battery reaches a supply interruption threshold value lower than the threshold value, the lower-level control unit interrupts, via a relay that interrupts an electric power supply from the second battery, the electric power supply from the second battery after notifying the upper-level control unit that the supply interruption threshold value has been reached.

According to this method, since it is possible to perform the monitoring of the charge amount of the second battery and the relay control with the lower-level control unit, it is possible to suppress the processing time needed for interrupting the electric power supply to a minimum and to decrease electric power consumption more than when the upper-level control unit performs the processing, because the monitoring of the charge amount of the second battery and the relay control is performed with the lower-level control unit.
(Configuration 12) The battery control method according to Configuration 11, wherein the lower-level control unit interrupts, via the relay, the electric power supply from the second battery after notifying the upper-level control unit that the supply interruption threshold value has been reached, based on a response from the upper-level control unit being received or a predetermined amount of time elapsing after the notifying.

According to this method, it is possible to suppress a delay in the relay control even when a response delay of the upper-level control unit occurs, and to suppress electric power consumption while preventing overdischarge of the second battery.

### REFERENCE SIGNS LIST

1 battery control system
2 first battery
3 second battery
4 electric power conversion unit
11 battery control unit
12 battery information acquisition unit
13 vehicle information acquisition unit (battery
temperature acquisition unit)
14 threshold value setting unit
15 timer processing unit
16 chargeability determination unit
17 abnormality determination unit
18 communication state detection unit
20 lower-level control unit (first lower-level control unit)
21, 31 charge amount monitoring unit (battery monitoring unit)
22, 32 charging necessity determination unit
30 lower-level control unit (second lower-level control unit)
41 relay

1. A battery control system installed in a mobile body, the battery control system comprising:
an upper-level control unit that controls charging of a first battery storing electric power for driving a power unit and a second battery charged with electric power of the first battery; and
a lower-level control unit that monitors the second battery, wherein
the upper-level control unit includes:
a battery information acquisition unit that acquires battery information relating to the first battery and the second battery;
a mobile body information acquisition unit that acquires mobile body information relating to the mobile body;
a threshold value setting unit that sets a threshold value defining a charge amount of the second battery, based on the battery information; and
a chargeability determination unit that determines whether the second battery can be charged based on the mobile body information, and transfers a determination result and the threshold value to the lower-level control unit, and
the lower-level control unit includes:
a charge amount monitoring unit that monitors the charge amount of the second battery; and
a charging necessity determination unit that transfers a charge request for the second battery to the upper-level control unit, when the determination result indicates that the second battery can be charged and the charge amount is equal to or lower than the threshold value.

2. The battery control system according to claim 1, wherein
the battery information includes a temperature of the second battery, and
the threshold value setting unit sets the threshold value based on the temperature.

3. The battery control system according to claim 1, wherein
the mobile body is a vehicle,
the mobile body information includes an open/closed state of at least one opening/closing member among a hood, doors, or a trunk of the vehicle, and
the chargeability determination unit does not determine that the second battery can be charged until a predetermined amount of standby time elapses, when the opening/closing member is put in an open state within a predetermined period of time after the vehicle ends a predetermined operation.

4. The battery control system according to claim 3, wherein the predetermined operation includes at least one of the vehicle traveling, the first battery being charged, or an electric power conversion unit converting electric power stored in the first battery to predetermined electric power while the vehicle is stopped.

5. The battery control system according to claim 1, further comprising a communication state detection unit that detects a communication state between the upper-level control unit and the lower-level control unit, wherein
the upper-level control unit charges the second battery during a preset timer amount of time without carrying out charging control of the second battery based on the charge request, when the communication state is abnormal.

6. The battery control system according to claim 1, wherein the charge amount monitoring unit continuously monitors the charge amount while the lower-level control unit is awake and intermittently monitors the charge amount while the lower-level control unit is asleep.

7. The battery control system according to claim 1, wherein
the upper-level control unit includes an abnormality determination unit that determines, among the first battery and the second battery, that at least the second battery is in an abnormal state, and
the abnormality determination unit counts the number of charges within a predetermined period of time based on the charge request, and determines that an abnormality has occurred in the second battery when the number of charges exceeds a predetermined value.

8. The battery control system according to claim 1, further comprising a relay that interrupts an electric power supply from the second battery, wherein
when the charge amount of the second battery reaches a supply interruption threshold value lower than the threshold value, the lower-level control unit interrupts, via the relay, the electric power supply from the second battery after notifying the upper-level control unit that the supply interruption threshold value has been reached.

9. The battery control system according to claim 8, wherein the lower-level control unit interrupts, via the relay, the electric power supply from the second battery after notifying the upper-level control unit that the supply interruption threshold value has been reached, when a response from the upper-level control unit is received or when a predetermined amount of time elapses as a condition.

10. A battery control method executed by a mobile body, the mobile body comprising:
an upper-level control unit that controls charging of a first battery storing electric power for driving a power unit and a second battery charged with electric power of the first battery; and
a lower-level control unit that monitors the second battery, wherein
the upper-level control unit executes:
a battery information acquisition step of acquiring battery information relating to the first battery and the second battery;
a mobile body information acquisition step of acquiring mobile body information relating to the mobile body;
a threshold value setting step of setting a threshold value defining a charge amount of the second battery, based on the battery information; and
a chargeability determination step of determining whether the second battery can be charged based on the mobile body information, and transferring a determination result and the threshold value to the lower-level control unit, and
the lower-level control unit executes:
a charge amount monitoring step of monitoring the charge amount of the second battery; and
a charging necessity determination step of transferring a charge request for the second battery to the upper-level control unit, when the determination result indicates that the second battery can be charged and the charge amount is equal to or lower than the threshold value.

11. The battery control method according to claim 10, wherein when the charge amount of the second battery reaches a supply interruption threshold value lower than the threshold value, the lower-level control unit interrupts, via a relay that interrupts an electric power supply from the second battery, the electric power supply from the second battery after notifying the upper-level control unit that the supply interruption threshold value has been reached.

12. The battery control method according to claim 11, wherein the lower-level control unit interrupts, via the relay, the electric power supply from the second battery after notifying the upper-level control unit that the supply interruption threshold value has been reached, based on a response from the upper-level control unit being received or a predetermined amount of time elapsing after the notifying.
